(19) United States
(12) Patent Application Publication
(10) Pub. No.: US 2017/0226241 A1
(43) Pub. Date: Aug. 10, 2017

(54) CHROMIUM-BASED CATALYST COMPONENT COMPRISING A MODIFIED INORGANIC OXIDE SUPPORT

(71) Applicants: SAUDI BASIC INDUSTRIES CORPORATION, Riyadh (SA); SABIC Global Technologies B.V., Bergen op Zoom (NL)

(72) Inventors: Khalid Al-Bahily, Riyadh (SA); Bander Al-Farhood, Riyadh (SA); Ibrahim Saleh Al-Hayyan, Riyadh (SA)

(21) Appl. No.: 15/039,700

(22) PCT Filed: Nov. 26, 2014
(86) PCT No.: PCT/EP14/75608

§ 371 Date: May 26, 2016

Related U.S. Application Data
(60) Provisional application No. 62/084,028, filed on Nov. 25, 2014.
(60) Provisional application No. 61/930,651, filed on Jan. 23, 2014.

(30) Foreign Application Priority Data
Nov. 28, 2013 (EP) 13194788.9
Nov. 17, 2014 (EP) 14193511.4

(51) Int. Cl. C08F 110/02

(52) U.S. Cl. CPC C08F 110/02

(57) ABSTRACT

The present invention relates to a catalyst component comprising an inorganic oxide supported chromium, wherein said inorganic oxide support has been modified by a metal halide modifier, preferably aluminum trichloride or aluminum trichloride hexahydrate. The present invention also relates to a process for obtaining such a catalyst component, a catalyst system comprising said catalyst component and a process for the polymerization of olefins using said catalyst system.

### BACKGROUND OF THE INVENTION

The invention relates to a catalyst component comprising an inorganic oxide supported chromium and to processes to prepare such a catalyst component. In addition, the present invention relates to the use of such a catalyst component in a catalyst system for polymerization of olefins, e.g. ethylene.

There is an ever increasing demand for high density polymers, for example high density polyethylene (HDPE). Since an increase in the molecular weight normally improves the physical properties of polyethylene resins, there is a strong demand for high molecular weight polyethylene. However, such a high molecular weight renders the polymers more difficult to process. A broadening of the molecular weight distribution tends to improve the flow of the polymer when it is subjected to high shear during processing. Thus in e.g. extrusion or blowing techniques (which subject the polymers to high shear) it is preferably to have polymers with high molecular weight distributions and high molecular weights.

The production processes of LDPE, HDPE and LLDPE are summarized in “Handbook of Polyethylene” by Andrew Peacock (2000; Dekker; ISBN 0824795466) at pages 43-66. The catalysts used can be divided in three different subclasses including Ziegler Natta catalysts, Phillips catalysts and single site catalysts. The various processes may be divided into solution polymerization processes employing homogeneous (soluble) catalysts and processes employing supported (heterogeneous) catalysts. The latter processes include both slurry and gas phase processes.

Phillips-type catalysts are a chromium oxide based catalyst. A specific type of Philips catalyst are the so called S-2 catalyst based on silyl chromate. In the publication of Cann et al. Macromol. Symp. 2004, 213, 29-36 the difference between these two types of catalyst is discussed. The present invention is related to said S-2 or silyl chromate based catalysts.

The preparation of such a silyl chromate catalyst component is for example disclosed in U.S. Pat. No. 3,324,101 disclosing that the silyl chromate catalyst can be supported on a silica support and in U.S. Pat. No. 3,324,095 disclosing the use of an alkyl-alkoxide-aluminum compound as co-catalyst. These catalyst and other prior art silyl chromate based catalyst systems are widely for HDPE production due to its good activity.

NL 7 711 007 discloses a method for the production of a polymerization catalyst, but no silyl chromate is used.

U.S. Pat. No. 5,310,834 discloses mixed catalyst compositions comprised of a first supported chromium-containing catalyst component and a second supported chromium-containing catalyst component, but no silyl chromate is used.

The publication of Kevin Cann et al. (Comparison of silyl chromate and chromium oxide based olefin polymerization catalyst, Macromolecular Symposia, vol. 213, no. 1, Jun. 1, 2004, pages 29-36 discloses silyl chromate catalysts but no prior modification with a metal halide modifier.

WO2004/076494 discloses the use of a silica-support silyl chromate catalyst system wherein an aluminum compound is used as a co-catalyst.

There is a need for novel silylchromate based catalyst with improved properties, such as an improved activity in the production of monomodal HDPE.

There is also a need for novel silylchromate based catalysts allowing the production of bimodal, high molecular weight HDPE having a very broad molecular weight distribution.

It is thus a first object of the present invention to provide a novel catalyst component with increased activity in the production of monomodal HDPE.

It is another object of the present invention to provide a novel catalyst component suitable for the production of HDPE with an increased molecular weight and an increased molecular weight distribution, e.g. even to above 35.

Moreover, it is another objection of the present invention to provide a novel catalyst component for the production of bimodal, high molecular weight HDPE.

It is the another object of the present invention to develop a highly active silyl chromate based catalyst component for the polymerization or co-polymerization of olefin, preferably ethylene, with similar or improved resin properties for example higher molecular weight and broader molecular weight distribution compared to the conventional silyl chromate based catalyst.

It is the another object of the present invention to develop a catalyst component resulting in a high productivity of the ethylene polymerization with similar or improved resin properties.

### SUMMARY

At least one of the aforementioned objects of the present invention is achieved with a catalyst component according to the present invention. The key feature of the present invention is that the inorganic oxide support is modified with either Group 13-metal active sites or with copper, vanadium, zinc or chromium active sites prior to the addition of the chromium active sites.

The catalyst can e.g. be prepared by reacting an inorganic oxide, such as silica, alumina or a combination thereof, with a metal halide in a solvent followed by a heat treatment (such as calcining). This process will lead to the coating of the surface of the inorganic oxide (e.g. silica) particles with either metal-oxo or metal-oxo-chloride groups, e.g. aluminum-oxo (using a hexahydrate aluminium) or aluminum-oxo-chloride (using a non-hydrate aluminium) groups. Without wishing to be bound by any theory, the present inventors propose that the presence of these modifier metal (e.g. aluminum) active sites increase the Lewis acidity of the catalyst. Following, the aluminum modified support is suspended in a solvent following by the addition of a silyl chromate, e.g. triphenyl silyl chromate. Preferably, during step of providing chromium active sites an aluminum compound as co-catalyst is also used—in addition to the metal modifier that is used to modify the silica support.

In a first preferred embodiment, the present invention relates to the coating of the silica surface of the support with aluminum chloride dissolved in water and then calcining under air. The modified support is then suspended, e.g. in isopentane, followed by the addition of a silyl chromate, e.g. triphenyl silyl chromate.

In a second preferred embodiment, the present invention relates to the coating of the silica surface of the support with aluminum chloride hexahydrate dissolved in water and then calcining under air. The modified support is then suspended, e.g. in isopentane, followed by the addition of a silyl chromate, e.g. triphenyl silyl chromate.

It has been surprisingly found by the present inventors that the activity of the novel catalyst component can be controlled by using a (hexa)hydrate modifier compared to a non-hydrate modifier.

It has moreover, been surprisingly found by the present inventors that the molecular weight, molecular weight distribution and crystallinity of the polymers produced using the novel catalyst component can be controlled by varying the percentage of metal-oxo-chloride that is formed during the preparation. As noted above, increasing the amount of non-hydrate modifier to a too high extent might lead to a decrease in productivity

In a first aspect, the present invention relates to a process for preparing an inorganic oxide-supported chromium catalyst component, said process comprising the steps of:
1) providing an inorganic oxide support;
2) modifying said support by a metal halide modifier, wherein said step of modifying comprising the sub steps of:
   2a) contacting said support provided in step 1) with said metal halide modifier to obtain an intermediate product; and
   2b) applying a heat treatment to said intermediate product obtained in step 2a) at a temperature between 400 and 800° C. to obtain a metal-modified support;
3) contacting said metal-modified support obtained in step 2b) with a silyl chromate compound to obtain the catalyst component.

In an embodiment, said inorganic oxide is silica, alumina or a combination thereof (e.g. a mixture of 10-90 wt. % of silica and 90-10 wt. % of alumina). In an embodiment, said inorganic oxide is silica having at most 20 wt. % of alumina and other metal oxides, more preferably at most 10 wt. %, even more preferably at most 5 wt. %. The weight percentage is based on the total weight of the solid support. In an embodiment, said inorganic oxide is silica. In other words, this weight percentage is not based on the weight of the final catalyst component.

In an embodiment, said metal halide of step 2a) and said silyl chromate of step 3) are used in such amounts that the resulting catalyst component comprises, in wt. % based on the total weight of the catalyst component, between 0.05 and 7.0, more preferably between 0.1 and 7.0 metal from metal halide (e.g. aluminum) and between 0.1 and 3.0 chromium. With “based on the total weight of the catalyst component” is meant the weight of the final product obtained after step 3) of the present invention, being the final catalyst component. This specific weight percentage is not based on the weight of only the solid support.

In an embodiment of the process, the catalyst component comprises, in wt. % based on the total weight of the catalyst component, between 0.05 and 7.0, more preferably between 0.1 and 7.0 metal from metal halide (e.g. aluminum) and between 0.1 and 3.0 chromium.

Preferably, the amount of metal from metal halide is at least 0.4 wt. %.

Preferably, the amount of metal from metal halide is at most 3.0 wt. %, more preferably at most 2.0 wt. %, even more preferably at most 1.2 wt. %.

Preferably, the amount of chromium is at least 0.4 wt. %.

Preferably, the amount of chromium is at most 2.0 wt. %, more preferably at most 1.5 wt. %, even more preferably at most 1.2 wt. %. This amount is measured by taking only the weight from the metal atom and not the counter ions.

In an embodiment, a non-hydrate metal halide is used as modifier. In other words, a metal halide having no crystal water. Preferably, said metal halide only has halide ligands and no other non-halide ligands are present. In an embodiment, aluminum trichloride (AlCl₃) is used as the metal halide in step 2a).

In another embodiment, a hydrate or hydrated metal halide is used. In other words, a metal halide having crystal water. Preferably, said metal halide only has halide ligands and no other non-halide ligands are present. In an embodiment, aluminum trichloride hexahydrate (AlCl₃(H₂O)₆) is used as the metal halide in step 2a).

In an embodiment, triphenyl silyl chromate is used as the silyl chromate in step 3).

In an embodiment, said metal-modified support obtained in step 2b) is a metal-oxo-chloride modified silica when aluminum trichloride (AlCl₃) is used as the metal halide in step 2a).

In another embodiment, said metal-modified support obtained in step 2b) is a metal-oxo modified silica when aluminum trichloride hexahydrate (AlCl₃(H₂O)₆) is used as the metal halide in step 2a).

In an embodiment, the heat treatment or calcination is carried out under an atmosphere of air or oxygen, preferably air. In an embodiment, said heat treatment is carried out at a temperature of at least 500° C., preferably, at least 550° C., more preferably at least 600° C.

In a second aspect, the present invention is relates to a catalyst component comprising an inorganic oxide supported chromium, wherein said inorganic oxide support has been modified by a metal halide modifier, wherein said catalyst component comprises in wt. % based on the total weight of the catalyst component, between 0.05 and 7.0, preferably between 0.1 and 7.0 metal from metal halide (e.g. aluminum) and between 0.1 and 3.0 chromium.

In other words, said second aspect relates to a catalyst component obtained by or obtainable by a method according to the first aspect, said catalyst component comprising an inorganic oxide supported chromium, wherein said inorganic oxide support has been modified by a metal halide modifier, wherein said catalyst component comprises in wt. % based on the total weight of the catalyst component, between 0.1 and 7.0 metal, and between 0.1 and 3.0 chromium.

Preferably, the amount of metal from metal halide is at least 0.4 wt. % in case a non-hydrate modifier is used or at least 0.1 wt. % when a hydrate modifier is used.

Preferably, the amount of metal from metal halide is at most 3.0 wt. %, more preferably at most 2.0 wt. %, even more preferably at most 1.2 wt. %.

Preferably, the amount of chromium is at least 0.4 wt. %.

Preferably, the amount of chromium is at most 2.0 wt. %, more preferably at most 1.5 wt. %, even more preferably at most 1.2 wt. %. This amount is measured by taking only the weight from the metal atom and not the counter ions.

In an embodiment, said catalyst component is obtainable by the process according to the present invention.

In a third aspect, the present invention relates to a polymerization catalyst system comprising the catalyst component and a co-catalyst.

In an embodiment, said co-catalyst is an alkyl aluminum alkoxide.

In a fourth aspect, the present invention relates to a process of preparing a polyolefin by contacting at least one olefin with a polymerization catalyst system under polymerization conditions.

In an embodiment, the olefin is ethylene or a combination of ethylene and a co-monomer, selected from the group of straight or branched propylenes, butenes, pentenes, hexenes, heptenes, and octenes.

In a fifth aspect, the present invention relates to a polyethylene obtainable by the polymerization process according to the present invention.

In an embodiment, said polyethylene obtained as a HLMI of between 1 and 20.

These aspects and embodiments will be described in more detail below.

### Definitions

The following definitions are used in the present description and claims to define the stated subject matter. Other terms not cited below are meant to have the generally accepted meaning in the field.

“Polyethylene” as used in the present description means: a polymer made of at least 50% ethylene-derived units, preferably at least 70% ethylene-derived units, more preferably at least 80% ethylene-derived units, even more preferably at least 90% ethylene-derived units, or at least 95% ethylene-derived units, or even 100% ethylene-derived units. The polyethylene can be a homopolymer or a copolymer, including a terpolymer.

“HDPE” as used in the present description means: a polyethylene having a density of greater or equal to 0.941 g/cm³. HDPE has a low degree of branching and thus low intermolecular forces and tensile strength. The lack of branching is ensured by an appropriate choice of catalyst and reaction conditions. HDPE is used in products and packaging such as milk jugs, detergent bottles, butter tubs, garbage containers, water pipes and toys.

“MWD” or “Molecular weight distribution” as used in the present description means: the same as “PDI” or “polydispersity index”. It is the ratio of the weight-average molecular weight (M_{w}) to the number average molecular weight (Mₙ), viz. M_{w}/Mₙ. and used as a measure of the broadness of molecular weight distribution of a polymer.

“surface area” or “SA” as used in the present description means: the total area of the surface of solid particles. It is expressed as m² per gram of material.

“Pore volume” or “PV” as used in the present description means: the volumes of the pores (expressed in cm³) per gram of material. When the pore volume is divided by the total volume of the material the porosity is obtained.

“monomodal” as used in the present description refers to a polymer or polymer composition, e.g. polyethylene, having a “monomodal molecular weight distribution”.

“bimodal” as used in the present description refers to a polymer or polymer composition, e.g. polyethylene, having a “bimodal molecular weight distribution”.

“monomodal molecular weight distribution” as used in the present description means: that the graph of the molecular weight distribution shows one single peak.

“bimodal molecular weight distribution” as used in the present description means: that the graph of the molecular weight distribution shows at least two separate peaks or one peak having a shoulder. It can for example mean a polymer composition with at least one polymer component having an identifiable higher molecular weight and at least one polymer component having an identifiable lower molecular weight. A material with more than two different molecular weight distribution peaks will be considered bimodal as this term is also used to refer to multimodal polymers or polymer compositions.

“Density” as used in the present description means: the density of the polymer or polymer compositions. It is a physical property of the composition and is determined in accordance with ASTM-D 792.

“HLMI” or “high load melt index” as used in the present description means: a measure of the ease of flow of the melt of a thermoplastic polymer under high load (viz. a load of 21.6 kg). It is defined as the mass of polymer, in grams, flowing in 10 minutes through a capillary of a 0.0825 inches diameter when subjected to a force of 21,600 grams at 190° C.

“Catalyst system” as used in the present description means: a system including at least one “catalyst component” and at least one “co-catalyst”.

“Catalyst component” or “catalyst compound” as used in the present description means: an inorganic oxide supported chromium-containing compound that, once appropriately activated, is capable of catalyzing the polymerization or oligomerization of olefins.

“hydrate” as used in the present description means: an inorganic salt containing one or more water molecules combined in a definite ratio as an integral part of the salt crystal.

“non-hydrate” as used in the present description means: an inorganic salt not containing any water molecules as an integral part of the salt crystal.

“co-catalyst” as used in the present description means: any compound or combination of compounds, that is added to a catalyst component to prepare a catalyst system. The co-catalyst is a reducing agent (reducing the chromium active site) that activate the catalyst. Moreover, the co-catalyst may also act as a water scavenger, therefore a small excess of the co-catalyst may be added to remove any water from the reactor. A separate or additional water scavenger may be added.

“water scavenger” as used in the present description means: a compound used to remove water from the polymerization reactor.

“hydrocarbyl” as used in the present description means: a hydrocarbon based ligand. Examples of hydrocarbyl ligands are discussed below.

“alkyl” as used in the present description means: an alkyl group (abbreviated with the symbol R) being a functional group or side-chain consisting of carbon and hydrogen atoms having only single bonds. An alkyl group may be straight or branched and may be un-substituted or substituted. It may also be cyclic in which case it is called an cycloalkyl group.

“alkenyl” as used in the present description means: an alkenyl or alkene group being a functional group or side-chain consisting of carbon and hydrogen atoms having at least one double bond. An alkenyl group may be straight or branched and may be un-substituted or substituted.

“alkoxide” or “alkoxy” as used in the present description means: a functional group or side-chain obtained from a alkyl alcohol. It consist of an alkyl (R) bonded to a negatively charged oxygen atom. An alkoxide is abbreviated with the symbols RO, where R is an alkyl.

“aryloxide” or “aryloxy” or “phenoxide” as used in the present description means: a functional group or side-chain obtained from an aryl alcohol. It consist of an aryl (Ph) bonded to a negatively charged oxygen atom. An aryloxide is abbreviated with the symbols RO or PhO, where Ph is an aryl.

“aryl” as used in the present description means: an aryl group being a functional group or side-chain derived from an aromatic ring. An aryl group may be straight or branched and may be un-substituted or substituted. It may or may not contain heteroatoms, such as oxygen (O), nitrogen (N), phosphorus (P), or sulphur (S). An aryl group also encloses “alkaryl” groups wherein one or more hydrogen atoms on the aromatic ring have been replaced by alkyl groups.

“aralkyl” as used in the present description means: an arylalkyl group being an alkyl group wherein one or more hydrogen atoms have been replaced by aryl groups.

“inorganic oxide” as used in the present description means: silicon oxide (silica), aluminum oxide (alumina), zirconium oxide (zirconia) or thorium oxide (thoria).

“Calcination” or “calcining” as used in the present description means: a thermal treatment process in presence of air applied to solid materials.

“aluminum halide” as used in the present description means: an aluminum compound having at least one halide ligands. It can e.g. be a monohalide aluminum, a dihalide aluminum, or a trihalide aluminum.

“halide” as used in the present description means: a halide ion (viz. a halogen atom) selected from the group of: fluoride (F⁻), chloride (Cl⁻), bromide (Br⁻) or iodide (I⁻)

“modifier” or “metal halide modifier” as used in the present description means: a compound that is capable of reacting with another compound and therewith modifying the chemical structure of that compound. In the context of the present invention said modifier modifies the support of a catalyst component.

“silyl chromate” or “silyl chromate compound” as used in the present description means” a compound comprising both aryl and/or alkyl silyl groups (e.g. —SiR₂— or —SiR₃ groups) as well as chromate (CrO₄²⁻) groups.

### DESCRIPTION OF THE DRAWINGS

FIGS. 1-15 are GPC traces obtained for examples 1-15 respectively.

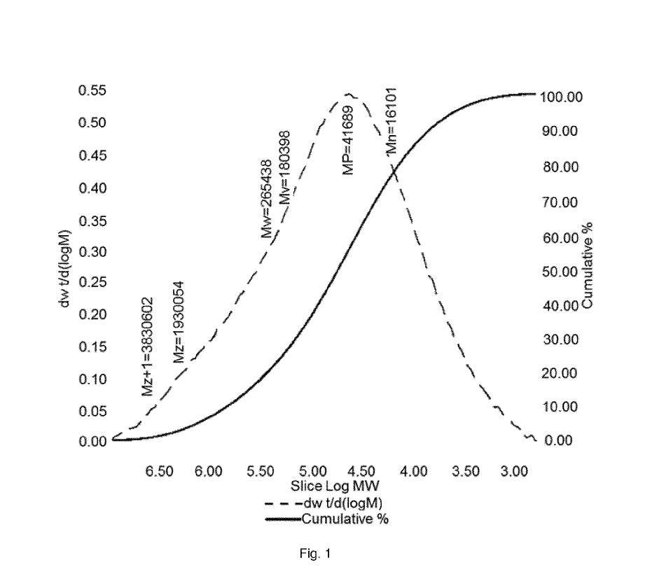

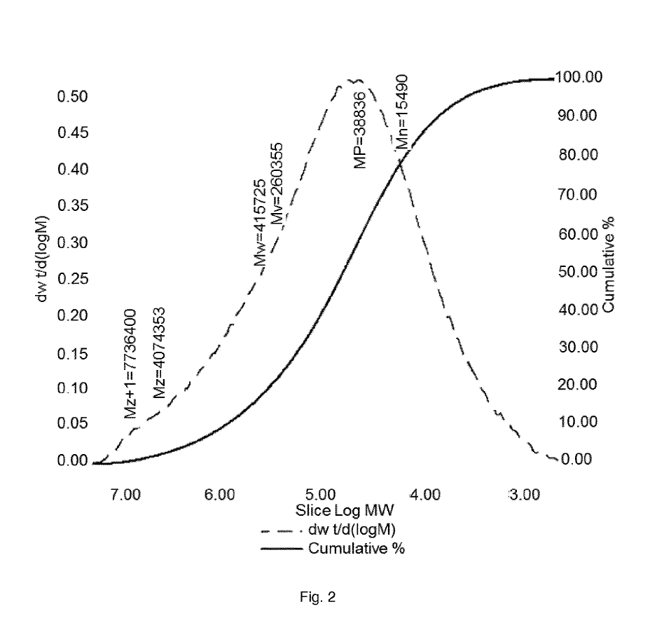

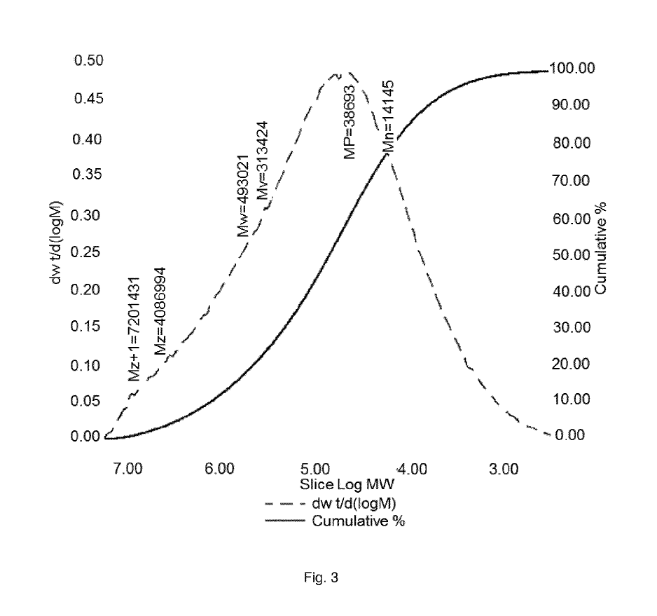

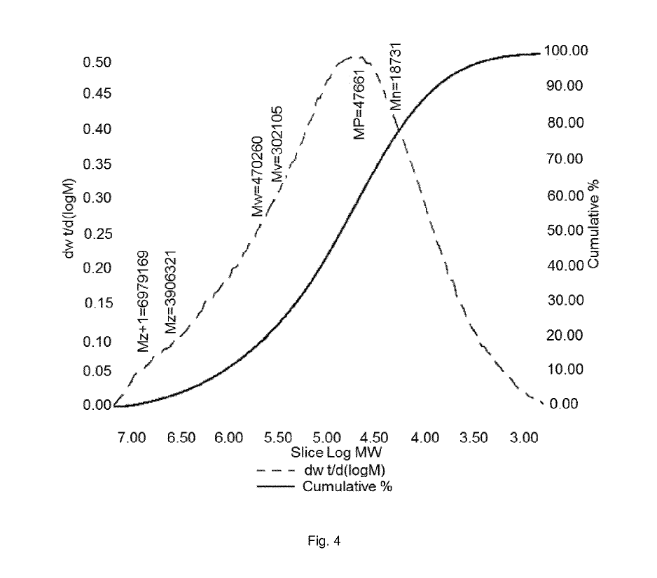

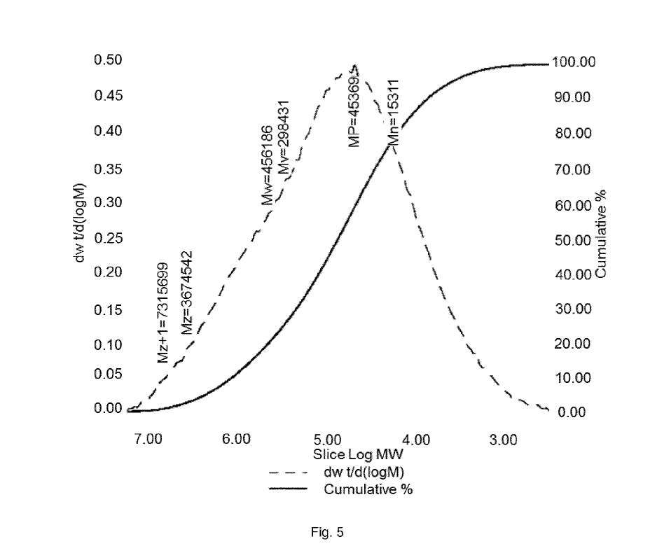

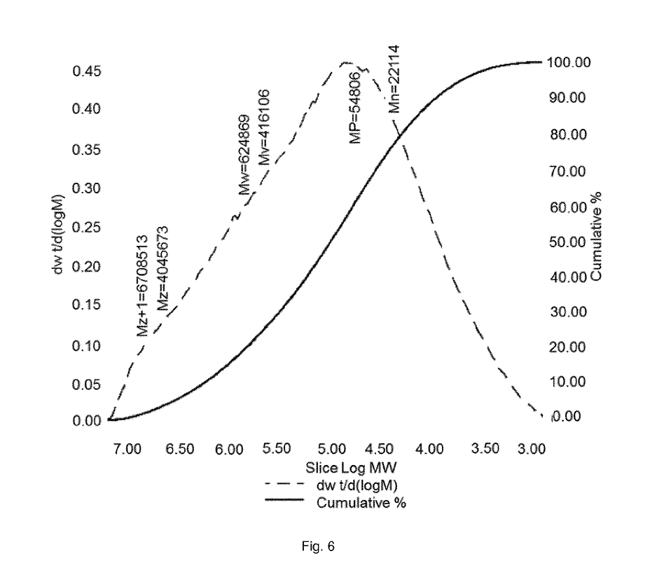

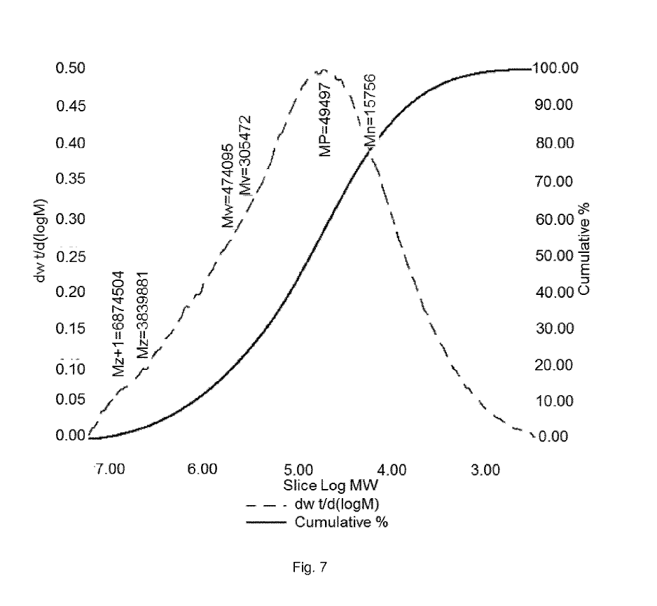

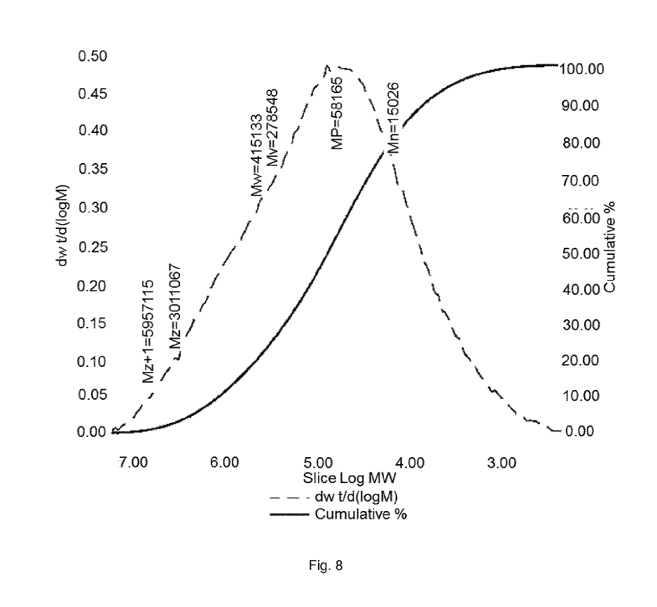

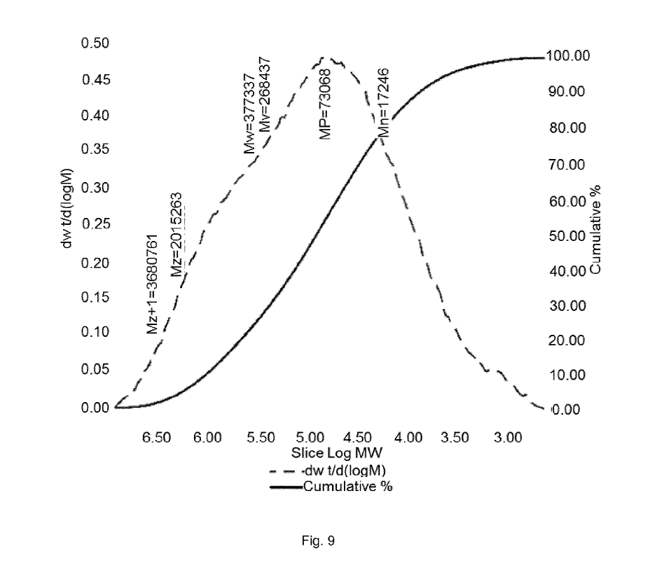

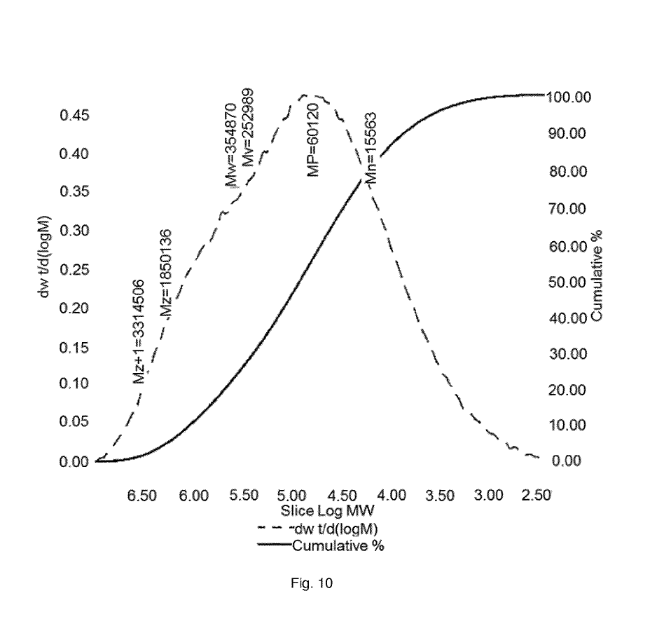

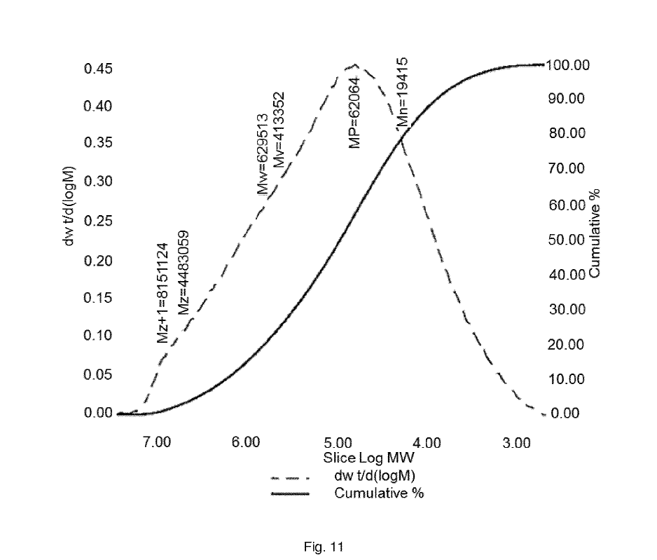

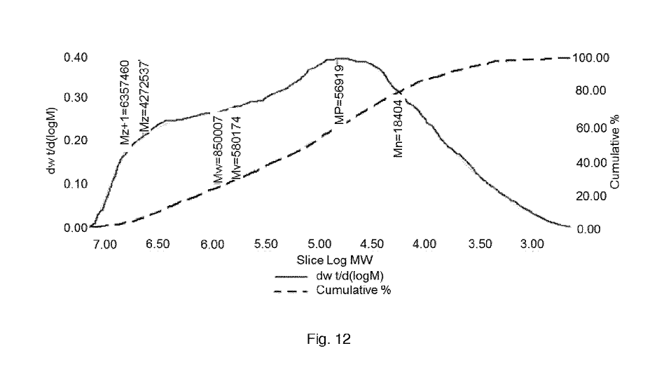

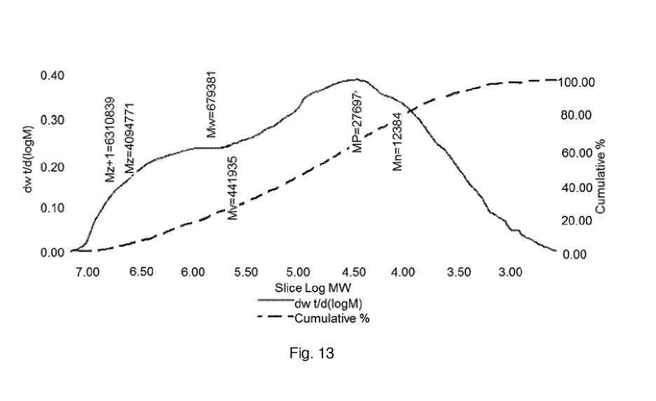

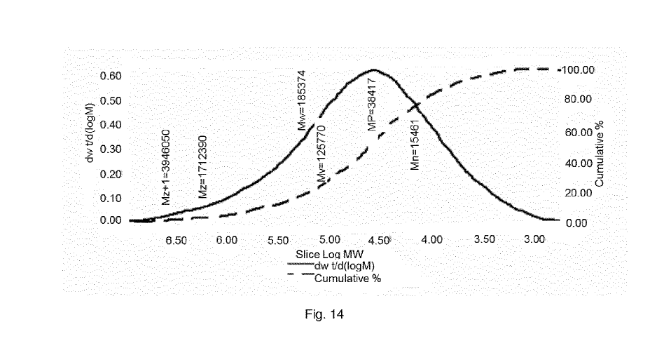

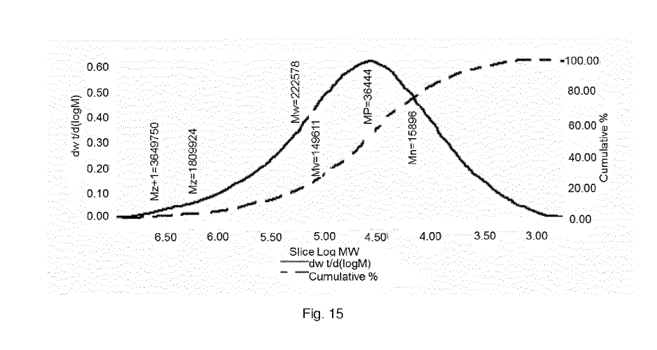

### DETAILED DESCRIPTION OF THE INVENTION

The present invention is described below in more detail. All embodiments described with respect to one aspect are also applicable to the other aspects of the invention, unless otherwise stated.

The present invention is involved with the modification of a support for a silyl chromate catalyst component or—stated otherwise—the addition of a second metal active site (e.g. aluminum) beside chromate. This additional secondary metal aluminum active site changes the behaviour of the primary chromium active site of the catalyst component.

As stated above the present process for preparing a polymerization catalyst component, comprising three steps. Each of which will be described in more detail below.

### Step 1) Inorganic Oxide Support

The first step in the preparation of the catalyst component consist in a step of providing an inorganic oxide support. During the remainder of this detailed description silica will be used as example of the inorganic support, although the invention is not limited thereto.

The inorganic support used for the present invention is preferably silicon dioxide or silica (SiO₂).

The silica that is useful as support according to the present invention may have a surface area (SA) larger than 150 m²/g and pore volume (PV) larger than 0.8 cm3/g. Examples of a suitable support for the preparation of silyl chromate based catalyst are the commercially available silica grades from W. R. Grace & co. (USA) being 955W and 4802, from PQ corp. (USA), being ES70, ES70W, MS3050, MS3040, from Asahi Glass Co. (Japan) being M302F, H302F, H202F.

According to a further optional embodiment of the invention—preferably when a non-hydrate metal modifier is used—water and other volatile compounds are removed from the support before it is modified. This can e.g. be carried out by heat activation of the support in a stream of an inert gas. An example of a suitable inert gas is nitrogen.

The inorganic oxide support is preferably provided in the form of particles.

Preferably, the particles have a size of between 10 and 100 micrometre. The particle size distribution of the particles is preferably between 42 and 50, more preferably between 45 and 47, as measured by ATSM D-4464-10. It can also be measured by ISO 13320:2009.

Surface area of the inorganic oxide support is preferably between 100 and 1000 m²/gram and more preferably between 250 to 500 m²/gram, even more preferably between 300 and 320 m²/gram, as measured by a static volumetric measurement technique according to ASTM (D-3663-03).

The pore volume (or porosity or void fraction) of the inorganic oxide support is preferably between 0.5 and 3.5 milliliters/gram, more preferably between 1.4 and 1.6 ml/gram, as measured by a static volumetric measurement technique according to ASTM (D-4222-03).

### Step 2) Modification of Support

The second step in the preparation of the catalyst component relates to the modification of the inorganic support. More precisely, the surface of the particles is modified by means of a metal modifier, wherein the metal is selected from Group 13 or the Periodic Table of elements and chromium, iron, vanadium, copper and zinc (viz. aluminum, boron, gallium, zinc, copper, thallium, indium, vanadium, chromium, and iron). Most preferably, said metal modifier is an aluminum modifier. Said metal modifier is preferably a monohalide, dihalide or trihalide of said metal, wherein the halide is selected from fluoride, chloride, bromide and iodide. Most preferably, said metal modifier only has halide ligands. In other words, the number of halide ligands is the same as the oxidation state of the metal. Preferably, all halide ligands are the same. When a metal halide is used (being an aluminum metal modifier) and silica is used as the support, the metal (e.g. aluminum) halide reacts with silanol (Si—OH) groups that are present at the surface of the silica particles. This step comprises two sub steps being, firstly contacting the support with the modifier and secondly applying a heat treatment.

According to the present invention non-limiting examples of suitable modifiers are the following. It should be noted that in the description of the present invention boron is considered to be a “metal” in the context of a “metal modifier”: aluminum trichloride, aluminum tribromide, aluminum triiodide, aluminum trifluoride, boron trichloride, boron tribromide boron triiodide, boron trifluoride, gallium trichloride, gallium tribromide, gallium triiodide, gallium trifluoride, zinc dichloride, zinc dibromide, zinc diiodide, zinc difluoride, copper dichloride, copper dibromide, copper diiodide, copper difluoride, copper chloride, copper bromide, copper iodide, copper fluoride, thallium trichloride, thallium tribromide, thallium triiodide, thallium trifluoride, thallium chloride, thallium bromide, thallium iodide, thallium fluoride, indium trichloride, indium tribromide, indium triiodide, indium trifluoride, vanadium trichloride, vanadium tribromide, vanadium triiodide, vanadium trifluoride, chromium trichloride, chromium dichloride, chromium tribromide, chromium dibromide, iron dichloride, iron trichloride, iron tribromide, iron dichloride, iron triiodide, iron diiodide, iron trifluoride, iron difluoride. Each of these can be used in a non-hydrate or hydrate form. A combination of two or more modifiers, either non-hydrate, hydrate or both may also be used. Most preferably aluminum trichloride in either a non-hydrate or hexahydrate form.

### Step 2a) Metal Halide Modifier Added to Support

This step is related to the addition of a metal halide to the support.

The modifier can be added to the support in a number of ways. For example, the support can be suspended in a solvent to which the modifier is added as such. Or a solution of the modifier can be made prior to contact with the support in suspension. It is preferred that a solution of modifier is used. More preferably, the solvents used for the suspension of the support and the solution of the modifier are similar or even the same.

Preferably, metal trihalides (e.g. aluminum trihalide) are used as the modifier, because it was found by the present inventors that during the step of heat treatment one or two halides are lost and the remaining halide(s) provide the metal-oxo or metal-oxo-chloride structure (for a hexahydrate and non-hydrate respectively) that will bond to the chromium and lower its acidity. The most preferred modifier is aluminum trichloride non-hydrate or aluminum trichloride hexahydrate.

The amount of metal halide used can be selected based on the percentage metal that is desired in the modified support. This can be used to tune the properties of the final catalyst component.

Preferably, the metal loading from the modifier (the amount of modifier metal present in the modified silica) is between 0.05 and 5.0 wt. %, preferably between 0.1 or even 0.4 and 1.2 wt. %, more preferably 0.8 wt. %. the present inventors have found that for an non-hydrate aluminum halide modifier when the amount of aluminum loading exceeded 5.0 wt. % the productivity dropped by 90% which is undesirable.

In an embodiment, the metal modifier is a non-hydrate aluminum and the aluminum loading (the amount of aluminum present in the modified silica) is between 0.05 and 5.0 wt. %, preferably between 0.1 or even 0.4 and 1.2 wt. %, more preferably 0.8 wt. %.

In an embodiment, the metal modifier is a hydrate aluminum and the aluminum loading (the amount of aluminum present in the modified silica) is between 0.1 and 5.0 wt. %, preferably between 0.4 and 1.2 wt. %, more preferably 0.8 wt. %.

Suitable solvents for both preparing the support suspension as a solution of the modifier are solvents having a boiling point above 50° C., preferably above 60° C. Solvents when using a non-hydrate modifier are preferably ethers (e.g. dibutyl ether, tetrahydrofuran, dioxane), chlorinated alkanes (e.g. chloroform), acetates (e.g. ethyl acetate), hydrocarbon solvents, more preferably selected from the group of alkanes (e.g. hexane, heptane, octane), aromatics (e.g. benzene, toluene). Preferably, the solvent is dibutylether when using a non-hydrate modifier.

Solvents when using a hydrate modifier are preferably polar solvents. Most preferably, the solvent is water when using a hydrate modifier.

The reaction is preferably carried out at a temperature between 30° C. and 70° C., more preferably 40° C. and 50° C.

The reaction mixture of silica and solvent is preferably premixed under stirring to provide a stable suspension before the modifier is added. This ensures an even distribution of the metal-oxo(-chloride) groups over the silica surface. Preferably, the stirring speed during premixing is between 200 and 600 ppm, more preferably between 300 and 500 rpm, such as between 350 and 450 rpm or 400 rpm.

Preferably, a solution of modifier contains between 5 and 40 wt. %, preferably between 10 and 30 wt. %, more preferably between 15 and 25 wt. % of modifier based on the total weight of the solution. When the solution is more diluted insufficient reaction will occur with the support. When the solution is more concentrated there might be a less homogeneous distribution of the metal-oxo(-chloride) groups over the silica surface. The solution of modifier is preferably added over a period of time to the silica suspension. For example, over a period of between 1 and 20 minutes, preferably between 5 and 15 minutes, more preferably between 8 and 12 minutes.

The total mixture (suspension of silica and solution of modifier) is mixed at a temperature of 30° C. and 70° C., more preferably 40° C. and 50° C. The temperature is preferably the same as for the preparation of the suspension of support above.

The duration of this reaction step is preferably between 10 minutes and 3 hours, more preferably between 30 minutes and 2 hours, such as 1 hour.

Preferably, the stirring speed during mixing is between 200 and 600 ppm, more preferably, between 300 and 500 rpm, such as between 350 and 450 rpm or 400 rpm. Preferably, the speed of mixing is the same as during the step of premixing the support and solvent.

Upon completion of the modification reaction, the solvent may be partially or completely removed. This removal may be by any known techniques, e.g. by filtration, decantation or by evaporation, preferably vacuum evaporation (e.g. rotary evaporation) but evaporation by heating is also possible. Preferably, the solvent is completely removed.

### Step 2b) Heat Treatment

The second sub step in this modification process is a heat treatment or thermal treatment. This heat treatment ensures that a metal-oxo(-halide) is formed, bound to the silica surface.

The heat treatment is carried out at a temperature between 400 and 800° C. Preferably, the heat treatment is carried out at temperatures between 500 and 700° C., more preferably between 550° C. and 650° C., even more preferably between 580 and 620° C.

The heat treatment is preferably carried out for a period of between 30 minutes and 10 hours, more preferably between 1 and 5 hours, even more preferably between 2 and 4 hours.

The heat treatment is for example carried out in a fluidized bed furnace. The heat treatment is preferably carried out in an atmosphere of air. The heat treatment is preferably carried out at ambient pressure. However the use of either elevated pressure (e.g. until 1.0 bar) or reduced pressure (e.g. until −1.0 bar) is also possible.

After the heat treatment, preferably the solid support is cooled to room temperature under an inert atmosphere (viz. an atmosphere without oxygen, e.g. a nitrogen atmosphere) and subsequently stored in an inert atmosphere.

After this step the solid, modified support may be subjected to analysis to determine the amount of aluminum that is present. The method of analysis is discussed in the Example section below.

The modification step 2) (combination of 2a) and 2b) leads to the addition of either metal-oxo-halide or metal-oxo to the silica support. This has been found by the present inventors to increases the acidity of the support, which becomes more electron withdrawing. If was found by the present inventors, that the presence of aluminum-oxo(-chloride) creates another active site in addition to chromium for the production of high molecular weight HDPE polymer chains resulting in e.g. bimodal resin (see Examples 12 and 13) with broad molecular weight distribution due to the dual character of the active site. Preferably, a MWD of above 35 or even above 50 is obtained. By tuning the percentage of aluminum-oxo(-chloride) present on the support, MW, MWD and crystallinity can be controlled. By adding more modifier to modify the solid support, the higher the MWD will be. However, simultaneously a decrease in productivity is observed for the non-hydrate modifier. A balance between a high MWD and a sufficiently high productivity should be sought. The present inventors also found that when using a hexahydrate aluminum chloride, aluminum-oxo species are formed with lead to the production of monomodal HDPE with a higher productivity (see Examples 14 and 15).

### Step 3) Chromation of Modified Support

During this step the active site chromium is added to the support. A silyl chromate is added to the modified support obtained from step 2). The silyl chromate may be added in an amount that is sufficient to obtain the desired chromium content. For example, the silyl chromate may be added in a weigh ratio of silyl chromate to support of 1:100 to 1:5, preferably between 1:60 and 1:10, such as between 1:10 and 1:30.

The silyl chromate compounds suitable for the present invention have one or more groups of the following formula:

—[Si(R)₂—O—Cr(═O)₂—O]—

wherein R can be any hydrocarbyl group having from 1 to about 14 carbon atoms.

Among the preferred compounds—in other words preferred silyl chromate compounds—containing said groups are the bis-trihydrocarbyl-silyl-chromates of the following formula:

Si(R)₃—O—Cr(═O)₂—O—Si(R)₃

wherein R is any hydrocarbyl group containing from 1 to about 14 carbon atoms, preferably from about 3 to about 10 carbon atoms. R can e.g. be an alkyl, alkylaryl, aryl, aralkyl group, preferably an aryl group because these are the most stable. Examples of the R groups are the following: methyl, ethyl, propyl, iso-propyl, iso-butyl, n-pentyl, isopentyl, hexyl, 2-methyl-pentyl, heptyl, octyl, 2-ethylhexyl, nonyl, decyl, dodecyl, tridecyl, tetradecyl, benzyl, phenetyl, p-methylbenzyl, phenyl, tolyl, xylyl, naphtyl, ehtylphenyl, methylnapthyl, dimethylnaphtyl, and others. Examples of more preferred silyl chromates are the following: bis-trimethyl-silyl-chromate, bis-triethyl-silyl-chromate, bis-tributyl-silyl-chromate, bis-triisopentyl-silyl-chromate, bis-tri-2-ethylhexyl-silyl-chromate, bis-tridecyl-silyl-chromate, bis-tri(tetradecyl)-silyl-chromate, bis-tribenzyl-silyl-chromate, bis-triphenetyl-silyl-chromate, bis-triphenyl-silyl-chromate, bis-tritolyl-silyl-chromate, bis-trixylyl-silyl-chromate, bis-trinaphtyl-silyl-chromate, bis-triethylphenyl-silyl-chromate, bis-trimethylnaphtyl-silyl-chromate, polydiphenylsilyl-chromate, polydiethylsilyl-chromate and the like.

Most preferred are the trisaryl-silyl-chromates because of their stability at room temperature and even under ambient air for up to several hours.

Suitable solvents for this step are solvents having a boiling point above room temperature (23° C.). Solvents are preferably hydrocarbon solvents, more preferably selected from the group of alkanes (e.g. isopentane, hexane, heptane, octane), aromatics (e.g. benzene, toluene), chlorinated alkanes (e.g. chloroform). Preferably, the solvent is isopentane.

The reaction mixture of modified silica and solvent is preferably premixed under stirring to provide a stable suspension before the silyl chromate is added. This ensures an even distribution of the chromate active sites over the silica surface. Preferably, the stirring speed during premixing is between 200 and 600 ppm, more preferably between 300 and 500 rpm, such as between 350 and 450 rpm or 400 rpm.

The reaction of step 3) is preferably carried out at room temperature (23° C.). Elevated temperatures up to 40 or 50° C. are also possible.

The total mixture (suspension of modified silica and chromate) is mixed for a duration of preferably between 10 minutes and 3 hours, more preferably between 30 minutes and 2 hours, such as 1 hour.

Preferably, the stirring speed during mixing is between 200 and 600 ppm, more preferably between 300 and 500 rpm, such as between 350 and 450 rpm or 400 rpm. Preferably, the speed of mixing is the same as during the step of premixing the modified support and solvent.

At the end of this step 3) a catalyst component is obtained. Preferably, the catalyst component comprises in wt. % based on the total weight of the catalyst component:
Aluminum or other modifier-metal: between 0.05 and 7.0 wt. %
Chromium: between 0.1 and 3.0 wt. %

The obtained catalyst component may be used as such (in a solvent) or may be isolated as a solid. It may be further washed, preferably with the solvent also used during the reaction; and then stored and further used as a suspension in said inert solvent. Alternatively, the product may be dried, preferably partly dried, preferably slowly and under mild conditions; e.g. at ambient temperature and pressure.

### Preparation of the Catalyst System

After step 3) has been carried out and a catalyst component is being prepared a co-catalyst may be added to obtain a catalyst system. A co-catalyst is present in order to increase the activity of the catalyst component formed.

Examples of co-catalyst are alkyl aluminum alkoxides having a formula of:

R₂—Al—OR₂

wherein R₂ can be an alkyl group having one to 12 carbon atoms, e.g. methyl, ethyl, n-propyl, i-propyl, n-butyl, i-butyl, t-butyl, hexyl, cyclohexyl, heptyl, cycloheptyl, and wherein OR₂ can be an alkoxy or aryloxy group, wherein R₂ can be selected from the same group as cited above, but may also be an aryl group having 6 to 20 carbon atoms, e.g. phenyl, tolyl, xylyl, mesityl, benzyl, phenyl and naphthyl. The R₂ groups can be the same or different. The most preferred co-catalyst is diethylaluminum ethoxide (Et₂AlEtO, known as DELOX).

Preferably, said co-catalyst is added prior to the polymerization reaction to a suspension of said catalyst component. Preferably, said co-catalyst is added in form of a solution. Said co-catalyst may also be added during the polymerization.

### Ratio of Metals in Catalyst Component

The amount of chromium in the catalyst component is generally at least 0.1% by weight. The amount of chromium in the catalyst component is generally at most 1.2% by weight.

When an aluminum-based co catalyst is used, the molar ratio of aluminum (co-catalyst) to chromium (catalyst component) ranges between 0.1:1 and 25:1, preferably 0.1:1 and 10:1.

The loading of chromium (weight percentage wt. %) in the final catalyst component preferably ranges between 0.1 and 1.2.

### Polymerization Process

The polymerization process can be carried out in different manners, for example under high pressure, in solution, in slurry and in gas phase. It can be carried out continuously or batch wise. A person skilled in the art will be able to determine the optimal conditions.

During the polymerization process, preferably, a solvent is present, also being described in more detail below. In addition, the olefin that is used, is described in more detail below.

It is preferred to carry out the polymerization process in the absence of moisture and oxygen. The catalyst component is present in an amount of 50 to 700 mg (total amount of catalyst), preferably between 250 mg and 500 mg.

The polymerization pressure is preferably between 1 and 40 bar, more preferably between 15 and 20 bar.

The polymerization temperature is preferably between 70 and 120° C., more preferably between 90 and 105° C.

The duration of polymerization is preferably between 30 and 90 minutes, more preferably between 50 and 70 minutes, such as 1 hour.

During the polymerization a water scavenger may be present. An example of water scavengers is triethyl aluminum (TEAL).

Hydrogen may the present during the polymerization in order to control the molecular weight (Mw) for different MWD values of the resulting polymer

The polyethylene obtained with the process according to the invention is suited to be applied in the production of large size blow molded articles (such as closed-head shipping containers, fuel tanks, and containers for industrial use) and high molecular weight film applications. Preferably, the polyethylene obtained has a HLMI value of between 1 and 20.

### Co-Catalyst

During polymerization a reducing agent is preferably present. The presence of such a reducing agent is known in the field. A person skilled in the art will be able to determine which reducing agents, as well as the amount, based on the circumstances of the polymerization.

As co-catalyst preferably structures corresponding to the following formula are used:

M(R′)ₐ(R″)_{b}

Wherein M is a metal selected from the group, consisting of aluminum, gallium and magnesium and is preferably aluminum.
each R′ independently is a saturated or unsaturated hydrocarbon group containing from about 1 to 20 carbon atoms. R′ can be an alkyl, aryl, aralkyl, alkenyl, cycloalkyl. Suitable examples of group R are methyl, ethyl, n-propyl, i-propyl, n-butyl, i-butyl, t-butyl, hexyl, cyclohexyl, heptyl, cycloheptyl, allyl, propenyl, phenyl, tolyl, xylyl, mesityl, benzyl, phenyl and naphthyl;
each R″ independently is either R′ or H;
a is an integer selected from 1, 2, or 3 and b is either 0, 1, or 2 on the proviso that a+b equals the valence of metal M.

It is preferred that M is aluminum. It is preferred that R′ is alkyl. Even more preferred are compounds wherein a is 3 and b is 0. Examples of suitable co-catalysts are trialkyl aluminum compounds, such as: trimethyl aluminum, triethyl aluminum (TEAL), tripropyl aluminum, tri-isobutyl aluminum (TIBA), tri-n-butyl aluminum; dialkyl aluminum hydrides, such as diethyl aluminum hydride, methyl-ethyl-aluminum hydride; tri aryl aluminum, such as triphenyl aluminum. Other examples are trialkyl gallium compounds, such as: trimethyl gallium, triethyl gallium, tripropyl gallium, tri-isobutyl gallium, tri-n-butyl gallium; dialkyl gallium hydrides, such as diethyl gallium hydride, methyl-ethyl-gallium hydride; tri aryl gallium, such as triphenyl gallium. Other examples are dialkyl magnesium compounds, such as: dimethyl magnesium, diethyl magnesium, dipropyl magnesium, di-isobutyl magnesium, di-n-butyl magnesium monoalkyl magnesium hydrides, such as ethyl magnesium hydride, methyl magnesium hydride; di aryl magnesium, such as diphenyl magnesium.

### Olefin

The olefin used in the polymerization according to the invention may be selected from ethylene or a combination of ethylene and a co-monomer, selected from mono- and di-olefins containing from 3 to 10 carbon atoms, such as for example branched or straight olefins selected from the following group propylene, butylene, pentene, hexene, heptene, octene, nonene, decene and/or butadiene. According to a preferred embodiment of the invention the olefin is ethylene.

### Solvent

The solvents or inert diluent or dispersant used during the polymerization may be selected from the group consisting liquefied ethane, propane, isobutene, n-butane, isopentane, n-hexane, other hexanes including cyclohexane, isooctane, paraffinic mixtures of alkanes having from 8 to t12 carbon atoms. The solvent is preferably isopentane.

The present invention will be further elucidated with the following examples without being limited hereto.

### EXAMPLES

### Step of Preparation of Modified Silica

[Step 2a]

Firstly, 50 g of silica (Silica 955 of Grace) was transferred into 500 mL round bottom flask. Dibutylether (250 ml, dried) was added as a solvent at room temperature. The mixture was then heated to a temperature of 50° C. and stirred at a stirring speed of 400 rpm.

Separately, a solution was prepared of either 2.16 g of AlCl₃ in 10 mL of dibutylether as the solvent (for Examples 1-11) or of 17.3 g of AlCl₃ in 10 mL of dibutylether as the solvent (for Examples 12-13) or AlCl₃(H₂O)₆ in 10 ml of water as the solvent (for Examples 14-15). This aluminum modifier solution was added slowly over a period of 10 minutes to the silica mixture. The resulting mixture was stirred for a period of 1 h at a temperature 50° C. and with a stirring speed of 400 rpm. Upon completion of the modification reaction, the solvent—dibutylether and optionally water—was removed by evaporation using vacuum.

[Step 2b]

Subsequently, the modified silica was subjected to a heat treatment (calcined) at a temperature of 600° C. under an air atmosphere during a period of 3 hours. The resulting solid product, being the modified silica contained either 0.8 wt. % (for Examples 1-11) or 4.5 wt. % (for Examples 12-13) of 0.1 wt. % (for Examples 14-15) of aluminum in the form of aluminum-oxo-chloride for examples 1-13 and aluminum-oxo for Examples 14-15.

### Step of Preparing the Catalyst

In 100 mL round bottom flask, a predetermined amount (as disclosed in Table 1) of a silyl chromate (bis-triphenyl silylchromate) and a predetermined amount (as disclosed in Table 1) of modified silica prepared in the previous step were added to 40 mL of isopentane. The resulting mixture was stirred at room temperature (23° C.) for 1 hour at a stirring speed of 300 rpm. Then, a predetermined amount (as disclosed in Table 1) of diethyl aluminum ethoxide (Et₂AlEtO, known as DELOX or DEALE) was added slowly to the mixture and stirred for 5 minutes (stirring speed of 300 rpm). This mixture is then ready for injection into the polymerization reactor to prepare the polymer. It should be noted that DELOX is used only as a co-catalyst. It does not form part of the catalyst component but does form part of the catalyst system. DELOX is added in the form of a 0.7 wt. % solution in isopentane.

The aluminum, magnesium and chromium content (loading) of the resulting catalyst components were tested by the following method: ICP (inductively coupled plasma) analysis.

### IPC Method

An amount of about 0.1 g of sample was weighed in a 50 mL centrifuge tube inside a glove box. This sample was subsequently removed from the glove box. Then 5 mL of concentrated nitric acid (HNO₃) is slowly added to the sample and stirred by using vortex mixture for about one minute. Inside a fume hood the lid of the centrifuge tube is opened to allow any fumes to escape from the sample. The opened centrifuge tube is left inside the fume hood occasional stirring for about one hour. Then, the sample was diluted to 50 mL by using deionized water. A blank was prepared in the same way except for the presence of the sample. In addition, standard were prepared for each of the different metals, said samples having concentrations of 0 mg/L, 1 mg/L, 5 mg/L, and 10 mg/L using valid certified individual element Mg, Ti and Al from a stock of 1000 mg/L. Sample analysis is performed by using a Thermo ICP system (Instrument ID: ICP-2). The instrument was standardized by using above mentioned standards. QC check standard (5 mg/L from different batch of the certified standard) is run to verify the calibration. A suitable dilution were made for the sample analyzed against the standard. The results will be reported for each element in %

The aluminum loading is the result of the metal halide modification of the inorganic oxide support. When an aluminum halide modifier is used it should be noted that the co-catalyst does not play in role in the aluminum content of the catalyst component.

The flow index is determined by HLMI (High Load Melt Index) Test Method ASTM D 1238 Condition F measured at 190° C. under a load of 21.6 kg and the results are given in g/10 minutes.

Polymer molecular weight and its distribution (MWD) were determined by Gel Permeation Chromatography (GPC) using a Polymer Labs 220 gel permeation chromatograph. The chromatograms were run at 150° C. using 1,2,4-trichlorobenzene as the solvent with a flow rate of 0.9 ml/min. The refractive index detector is used to collect the signal for molecular weights. The software used is Cirrus from PolyLab for molecular weights from GPC. The calibration of the HT-GPC uses a Hamielec type calibration with broad standard and fresh calibration with each sample set.

### Example 1 (Comparative)

A standard silica 955W from W. R. Grace was used. This was subsequently contacted in an amount of 250 mg with 8.9 mg bis-triphenyl silylchromate and 0.2 ml of a solution of diethyl aluminum ethoxide (7 wt. % in isopentane). The catalyst component of the resulting catalyst system had a chromium content of 0.29 wt. % and an aluminum content of 0 wt. % since no aluminum modification of the silica is carried out in this comparative example.

### Example 2

A modified silica prepared as discussed above was used. This was subsequently contacted in an amount of 250 mg with 17.8 mg bis-triphenyl silylchromate and 0.4 ml of a solution of diethyl aluminum ethoxide (7 wt. % in isopentane). The catalyst component of the resulting catalyst system had a chromium content of 1 wt. % and an aluminum content of 0.8 wt. %.

### Example 3

A modified silica prepared as discussed above was used. This was subsequently contacted in an amount of 250 mg with 17.8 mg bis-triphenyl silylchromate and 0.7 ml of a solution of diethyl aluminum ethoxide (7 wt. % in isopentane). The catalyst component of the resulting catalyst system had a chromium content of 1 wt. % and an aluminum content of 0.8 wt. %.

### Example 4

A modified silica prepared as discussed above was used. This was subsequently contacted in an amount of 250 mg with 17.8 mg bis-triphenyl silylchromate and 1.0 ml of a solution of diethyl aluminum ethoxide (7 wt. % in isopentane). The catalyst component of the resulting catalyst system had a chromium content of 1 wt. % and an aluminum content of 0.8 wt. %.

### Example 5

A modified silica prepared as discussed above was used. This was subsequently contacted in an amount of 250 mg with 17.8 mg bis-triphenyl silylchromate and 1.3 ml of a solution of diethyl aluminum ethoxide (7 wt. % in isopentane). The catalyst component of the resulting catalyst system had a chromium content of 1 wt. % and an aluminum content of 0.8 wt. %.

### Example 6

A modified silica prepared as discussed above was used. This was subsequently contacted in an amount of 250 mg with 17.8 mg bis-triphenyl silylchromate and 1.7 ml of a solution of diethyl aluminum ethoxide (7 wt. % in isopentane). The catalyst component of the resulting catalyst system had a chromium content of 1 wt. % and an aluminum content of 0.8 wt. %.

### Example 7

A modified silica prepared as discussed above was used. This was subsequently contacted in an amount of 500 mg with 33 mg bis-triphenyl silylchromate and 1.3 ml of a solution of diethyl aluminum ethoxide (7 wt. % in isopentane). The catalyst component of the resulting catalyst system had a chromium content of 1 wt. % and an aluminum content of 0.8 wt. %.

### Example 8

A modified silica prepared as discussed above was used. This was subsequently contacted in an amount of 500 mg with 33 mg bis-triphenyl silylchromate and 1.52 ml of a solution of diethyl aluminum ethoxide (7 wt. % in isopentane). The catalyst component of the resulting catalyst system had a chromium content of 1 wt. % and an aluminum content of 0.8 wt. %.

### Example 9

A modified silica prepared as discussed above was used. This was subsequently contacted in an amount of 500 mg with 33 mg bis-triphenylsilylchromate and 1.7 ml of a solution of diethylaluminum ethoxide (7 wt. % in isopentane). The catalyst component of the resulting catalyst system had a chromium content of 1 wt. % and an aluminum content of 0.8 wt. %.

### Example 10

A modified silica prepared as discussed above was used. This was subsequently contacted in an amount of 500 mg with 33 mg bis-triphenyl silylchromate and 2.0 ml of a solution of diethyl aluminum ethoxide (7 wt. % in isopentane). The catalyst component of the resulting catalyst system had a chromium content of 1 wt. % and an aluminum content of 0.8 wt. %.

### Example 11

A modified silica prepared as discussed above was used. This was subsequently contacted in an amount of 500 mg with 33 mg bis-triphenyl silylchromate and 2.5 ml of a solution of diethyl aluminum ethoxide (7 wt. % in isopentane). The catalyst component of the resulting catalyst system had a chromium content of 1 wt. % and an aluminum content of 0.8 wt. %.

### Example 12

A modified silica prepared as discussed above was used. This was subsequently contacted in an amount of 500 mg with 30 mg bis-triphenyl silylchromate and 0.7 ml of a solution of diethyl aluminum ethoxide (7 wt. % in isopentane). The catalyst component of the resulting catalyst system had a chromium content of 0.9 wt. % and an aluminum content of 4.5 wt. %.

### Example 13

A modified silica prepared as discussed above was used. This was subsequently contacted in an amount of 500 mg with 30 mg bis-triphenyl silylchromate and 0.25 ml of a solution of diethyl aluminum ethoxide (7 wt. % in isopentane). The catalyst component of the resulting catalyst system had a chromium content of 0.9 wt. % and an aluminum content of 4.5 wt. %.

### Example 14

A modified silica prepared as discussed above was used. This was subsequently contacted in an amount of 250 mg with 8.9 mg bis-triphenyl silylchromate in 40 mL of isopentane. Then 0.2 mL of a solution of diethyl aluminum ethoxide (7 wt. % in isopentane) was added and stirred for 5 minutes. The catalyst component of the resulting catalyst system had a chromium content of 0.29 wt. % and an aluminum content of 0.1 wt. %.

### Example 15

A modified silica prepared as discussed above was used. This was subsequently contacted in an amount of 250 mg with 8.9 mg bis-triphenyl silylchromate in 40 mL of isopentane. Then 0.35 mL of a solution of diethyl aluminum ethoxide (7 wt. % in isopentane) was added and stirred for 5 minutes. The catalyst component of the resulting catalyst system had a chromium content of 0.29 wt. % and an aluminum content of 0.1 wt. %.

### Ethylene Polymerization

The polymerization reaction was carried out in a stirred autoclave reactor. The reaction is carried out in 1 L of deoxygenated isopentane in the presence of an alkyl aluminum water scavenger, viz. 0.1 ml (1 M) of triethylaluminum, also known as TEAL). The polymerization reaction in the presence of the catalyst components 1-15 was conducted at 100° C. and 20 bars (290 psi) of total pressure. Ethylene polymerization was carried out for 1 hour, with ethylene supplied on demand to maintain the total reactor pressure at 20 bar. Upon completion of the polymerization, the reactor was vented and cooled to ambient temperature to recover the polymer.

The results are shown in Table 1.

In Table 1 Mw is the weight-average molecular weight. M_{w} is related to strength properties (tensile, impact resistance). Mₙ is the number-average molecular weight; Mₙ is related to brittleness, and flow properties. PDI is the polydispersity index or molecular weight distribution. Productivity relates to the effectiveness of the catalyst component in olefin polymerization. Polymer bulk density is defined as the weight per unit volume of polymer.

| Example Nr. | 1 | 2 | 3 | 4 | 5 | 6 | 7 | 8 |
|---|---|---|---|---|---|---|---|---|
| Type of Silica^{#1} | ST | MD | MD | MD | MD | MD | MD | MD |
| amount (mg) | 250 | 250 | 250 | 250 | 250 | 250 | 500 | 500 |
| Silyl chromate (mg) | 8.9 | 17.8 | 17.8 | 17.8 | 17.8 | 17.8 | 33.0 | 33.0 |
| Al wt. % | 0 | 0.8 | 0.8 | 0.8 | 0.8 | 0.8 | 0.8 | 0.8 |
| Cr wt. % | 0.29 | 1 | 1 | 1 | 1 | 1 | 1 | 1 |
| Detox (7 wt. %) (ml) | 0.2 | 0.4 | 0.7 | 1.0 | 1.3 | 1.7 | 1.3 | 1.52 |
| Productivity^{#2} | 0.98 | 1.38 | 1.05 | 1.1 | 0.72 | 0.7 | 1.01 | 1.13 |
| Mw^{#3} | 227,000 | 417,000 | 493,000 | 470,000 | 475,000 | 625,000 | 474,000 | 416,000 |
| PDI | 15 | 27.8 | 35.2 | 24.7 | 30.4 | 28.5 | 29.5 | 27.73 |
| Mn^{#4} | 15,000 | 15,000 | 14,000 | 19,000 | 15,000 | 22,000 | 16,000 | 15,000 |
| PBD^{#5} | 40 | 40 | 38 | 38 | 35 | 39 | 40 | 43 |
| HLMI (21.5 kg)^{#6} | 27.01 | 3.53 | 2.15 | 2.31 | 1.64 | 1.40 | 2.90 | 3.45 |
| FIG. (drawings) | 1 | 2 | 3 | 4 | 5 | 6 | 7 | 8 |

| Example Nr. | 9 | 10 | 11 | 12 | 13 | 14 | 15 |
|---|---|---|---|---|---|---|---|
| Type of Silica^{#1} | MD | MD | MD | MD | MD | MD | MD |
| amount (mg) | 500 | 500 | 500 | 500 | 500 | 500 | 500 |
| Silyl chromate (mg) | 33.0 | 33.0 | 33.0 | 30.0 | 30.0 | 8.9 | 8.9 |
| Al wt. % | 0.8 | 0.8 | 0.8 | 4.5 | 4.5 | 0.1 | 0.1 |
| Cr wt. % | 1 | 1 | 1 | 0.9 | 0.9 | 0.29 | 0.29 |
| Detox (7 wt. %) (ml) | 1.7 | 2.0 | 2.5 | 0.7 | 0.25 | 0.2 | 0.35 |
| Productivity^{#2} | 0.81 | 0.73 | 0.85 | 0.20 | 0.31 | 2.7 | 1.4 |
| Mw^{#3} | 378,000 | 355,000 | 631,000 | 850,007 | 679,381 | 185,000 | 223,000 |
| PDI | 22.2 | 22 | 33.2 | 46.1 | 54.86 | 12.3 | 14 |
| Mn^{#4} | 17,000 | 16,000 | 19,000 | 18,404 | 12,384 | 15,000 | 16,000 |
| PBD^{#5} | 40 | 43 | 42 | 41 | 38 | 43 | 39 |
| HLMI (21.6 kg)^{#6} | 2.35 | 2.45 | 1.74 | 0.43 | 0.57 | 26.79 | 14.87 |
| FIG. (drawings) | 9 | 10 | 11 | 12 | 13 | 14 | 15 |

^{#1}ST is standard silica, being Grace 955W, MD is silica modified as disclosed in the Examples of the present invention
^{#2}productivity is measured in kilograms of polymer per gram of catalyst per hour
^{#3}the unit of M_{w} is gram per mole
^{#4}the unit of Mₙ is gram per mole
^{#5}the unit of polymer bulk density is grams per 100 millilitres
^{#6}the unit of HLMI is the mass of polymer, in grams

Thus, it has been shown that the catalyst component according to the present invention modified using an aluminum chloride modifier (Examples 2-13) is able to provide a polymer having a high molecular weight and high molecular weight distribution. Moreover, it has been shown that the catalyst component according to the present invention modified using an aluminum chloride hexahydrate modifier (Examples 14 and 15) provides a monomodal polymer with an very large increase in productivity while maintaining a similar molecular weight and molecular weight distribution.

Thus, one or more of the objections of the present invention are achieved by the present catalyst component.

More embodiments are disclosed in the appended claims.

1. A process for preparing an inorganic oxide-supported chromium catalyst component, said process comprises:
1) providing an inorganic oxide support;
2) modifying said support by a metal halide modifier, wherein said step of modifying comprising the sub steps of:
2a) contacting said support provided in step 1) with said metal halide modifier to obtain an intermediate product; and
2b) applying a heat treatment to said intermediate product obtained in step 2a) at a temperature between 400 and 800° C. to obtain a metal-modified support;
3) contacting said metal-modified support obtained in step 2b) with a silyl chromate compound to obtain the catalyst component.

2. The process according to claim 1, wherein said inorganic oxide is silica.

3. The process according to claim 1, wherein said metal halide of step 2a) and said silyl chromate of step 3) are used in such amounts that the resulting catalyst component comprises, in wt. % based on the total weight of the catalyst component, between 0.1 and 7.0 metal from modifier and between 0.1 and 3.0 chromium.

4. The process according to claim 1, wherein aluminum trichloride (AlCl₃) or aluminum trichloride hexahydrate (AlCl₃(H₂O)₆) is used as the metal halide in step 2a).

5. The process according to claim 1, wherein bis-triphenyl silyl chromate is used as the silyl chromate in step 3).

6. The process according to claim 2, wherein said metal-modified support obtained in step 2b) is a metal-oxo-chloride modified silica in case that aluminum trichloride is used or wherein said metal-modified support obtained in step 2b) is a metal-oxo modified silica in case that aluminum trichloride hexahydrate is used.

7. A catalyst component comprising an inorganic oxide supported chromium, characterized in that said inorganic oxide support has been modified by a metal halide modifier, wherein said catalyst component comprises in wt. % based on the total weight of the catalyst component, between 0.1 and 7.0 metal, and between 0.1 and 3.0 chromium.

8. A catalyst component according to claim 7 wherein said metal is selected from the group consisting of aluminum, boron, gallium, zinc, copper, thallium, indium, vanadium, chromium, and iron.

9. The catalyst component according to claim 8 that is obtainable by the process comprising
1) providing an inorganic oxide support;
2) modifying said support by a metal halide modifier, wherein said step of modifying comprising the sub steps of:
2a) contacting said support provided in step 1) with said metal halide modifier to obtain an intermediate product; and
2b) applying a heat treatment to said intermediate product obtained in step 2a) at a temperature between 400 and 800° C. to obtain a metal-modified support;
3) contacting said metal-modified support obtained in step 2b) with a silyl chromate compound to obtain the catalyst component.

10. A polymerization catalyst system comprising the catalyst component according to claim 8.

11. The polymerization catalyst system according to claim 10, wherein said co-catalyst is an alkyl aluminum alkoxide.

12. A process of preparing a polyolefin by contacting at least one olefin with a polymerization catalyst system according to claim 10 under polymerization conditions.

13. The process according to claim 12, wherein the olefin is ethylene or a mixture of ethylene and a comononer.

14. A polyethylene obtainable by the process of claim 13.

15. A polyethylene according to claim 14, having a high load melt index between 1 and 20.
